(19) United States
(12) Patent Application Publication
(10) Pub. No.: US 2011/0252702 A1
(43) Pub. Date: Oct. 20, 2011

(54) RAISED GARDEN SYSTEM

(76) Inventor: Albert S. GAZJUK, Waxhaw, NC (US)

(21) Appl. No.: 13/087,691

(22) Filed: Apr. 15, 2011

Related U.S. Application Data
(60) Provisional application No. 61/324,489, filed on Apr. 15, 2010.

(51) Int. Cl. A01G 1/08

(52) U.S. Cl. 47/33

(57) ABSTRACT

A raised garden system includes a plurality of structural members that include a plurality of side rails. The raised garden system further includes a plurality of tapered bracket assemblies, each of which includes a tapered male bracket that slides into a tapered female bracket. Each side rail may be connected to at least one other structural member via a bracket assembly, wherein one of the male bracket and the female brackets is fastened to the side rail and the other of the male bracket and the female bracket is fastened to the other structural member. When assembled, the structural members form a raised garden, the sides of which are at least partially formed from the side rails, and which is held together by the tapered bracket assemblies.

### CROSS-REFERENCE TO RELATED APPLICATION

The present application is a U.S. non-provisional patent application of, and claims priority under 35 U.S.C. §119(e) to, U.S. provisional patent application Ser. No. 61/324,489, filed Apr. 15, 2010 and entitled “EASILY ASSEMBLED RAISED GARDEN SYSTEM,” which is expressly incorporated by reference herein in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

### Field of the Present Invention

The present invention relates generally to raised gardens, and, in particular, to raised garden kits and other systems that may be easily assembled by a user with little or no use of tools.

### Background

Raised gardens are well known and growing in popularity. Their construction is typically not complicated but can be tedious, the results can be uneven and sometimes unappealing, and many gardeners would rather not endure such a process. Unfortunately, easy to assemble kits have not been heretofore available. Thus, a need exists for a system, especially in kit form, that may be easily assembled by a user with little or no use of tools.

### SUMMARY OF THE PRESENT INVENTION

The present invention comprises a raised garden system.

Broadly defined, the present invention according to one aspect is a garden structure as shown and described.

Broadly defined, the present invention according to another aspect is a raised garden system as shown and described.

Broadly defined, the present invention according to another aspect is a raised garden system having at least one pair of structures that are connected together via a tapered male bracket that slides into a tapered female bracket.

Broadly defined, the present invention according to another aspect is a raised garden system having posts and side rails, wherein the side rails are connected to the posts using tapered bracket assemblies.

In feature of this aspect, two side rails are stacked edge-to-edge on top of each other; and a first of the two side rails is an upper side rail and is connected to an upper bracket on the post by sliding tapered male and female brackets together from the top, and a second of the two side rails is a lower side rail and is connected to a lower bracket on the post by sliding tapered male and female brackets together from the bottom.

Broadly defined, the present invention according to another aspect is a raised garden system kit as shown and described.

Broadly defined, the present invention according to still another aspect is a raised garden system that includes a plurality of structural members and a plurality of tapered bracket assemblies. The plurality of structural members includes a plurality of side rails, and each bracket assembly includes a tapered male bracket that slides into a tapered female bracket. Each side rail may be connected to at least one other structural member via a bracket assembly, wherein one of the male bracket and the female brackets is fastened to the side rail and the other of the male bracket and the female bracket is fastened to the other structural member. When assembled, the structural members form a raised garden, the sides of which are at least partially formed from the side rails, and which is held together by the tapered bracket assemblies.

In features of this aspect, the plurality of structural members may further include a plurality of posts, wherein the side rails are connected to the posts using the tapered bracket assemblies; two side rails may be stacked edge-to-edge on top of each other; and a first of the two side rails may be an upper side rail and is connected to an upper bracket on a post by sliding first tapered male and female brackets together from the top, and a second of the two side rails may be a lower side rail and is connected to a lower bracket on the post by sliding second tapered male and female brackets together from the bottom.

In other features of this aspect, the side rails may be connectable to the posts without tools using the tapered bracket assemblies; and the side rails, posts and tapered bracket assemblies may be provided to a consumer in the form of a kit to be assembled by the consumer.

In other features of this aspect, the raised garden system may further include a pair of elongated posts for supporting a trellis, the elongated posts being connectable to one or more side rails using tapered bracket assemblies; the elongated posts may be adapted to be connected on sides of the side rails; the elongated posts may be provided with the side rails and tapered bracket assemblies to a consumer in the form of a kit to be assembled by the consumer; and the elongated posts may form corner posts of the raised garden formed by the structural members.

In still other features of this aspect, the structural members may include four corner posts, four upper side rails and four lower side rails, which, together with sixteen tapered bracket assemblies, form a rectangular garden; the structural members may include four corner posts, two side posts, six upper side rails and six lower side rails, which, together with twenty-four tapered bracket assemblies, form a rectangular garden; and the structural members may include six corner posts, six upper side rails and six lower side rails, which, together with twenty-four tapered bracket assemblies, form a hexagonal garden.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1A is a front elevational view of a raised garden system in accordance with a first preferred embodiment of the present invention;

FIG. 1B is a top plan view of the raised garden system of FIG. 1A;

FIG. 1C is a front cross-sectional view of the raised garden system of FIG. 1A, taken along line 1C-1C;

FIG. 2 is a fragmentary perspective view of a portion of the raised garden system of FIG. 1A, shown in a disassembled state;

FIG. 3A is an elevational view of one of the bracket assemblies of FIG. 1C;

FIG. 3B is an end view of the bracket assembly of FIG. 3A;

FIG. 4A is a front elevational view of one of the male brackets of FIG. 3A;

FIG. 4B is a rear elevational view of the male bracket of FIG. 4A;

FIG. 4C is an end view of the male bracket of FIG. 4A;

FIG. 5A is a front elevational view of one of the female brackets of FIG. 3A;

FIG. 5B is a rear elevational view of the female bracket of FIG. 5A;

FIG. 5C is an end view of the female bracket of FIG. 5A;

FIG. 6A is a top plan view of a raised garden system in accordance with a second preferred embodiment of the present invention;

FIG. 6B is a front elevational view of the raised garden system of FIG. 6A, illustrating the assembly thereof;

FIG. 6C is a fragmentary perspective view of a portion of the raised garden system of FIG. 6A, illustrating the assembly thereof;

FIG. 7A is a front elevational view of a raised garden system, in accordance with a third preferred embodiment of the present invention, wherein some hidden edges are shown in broken lines;

FIG. 7B is a top plan view of the raised garden system of FIG. 7A;

FIG. 7C is a right side elevational view of the raised garden system of FIG. 7A, wherein some hidden edges are shown in broken lines;

FIG. 8 is a front plan view of the raised garden system of FIG. 7A, shown with a trellis installed thereon;

FIGS. 9A and 9B are a side elevational view and a front elevational view, respectively, of a garden workbench, in accordance with a fourth preferred embodiment of the present invention, wherein some hidden edges are shown in broken lines;

FIG. 10A is a front elevational view of a raised garden system in accordance with a fifth preferred embodiment of the present invention;

FIG. 10B is a front cross-sectional view of the raised garden system of FIG. 10A, taken along line 10B-10B of FIG. 11A;

FIG. 10C is a front cross-sectional view of the raised garden system of FIG. 10A, taken along line 10C-10C of FIG. 11A;

FIG. 11A is a top plan view of the raised garden system of FIG. 10A, wherein some hidden edges are shown in broken lines;

FIG. 11B is a front elevational view of the raised garden system of FIG. 10A, wherein some hidden edges are shown in broken lines;

FIG. 11C is a front elevational view of one of the poses of the raised garden system of FIG. 10A, wherein some hidden edges are shown in broken lines;

FIG. 12A is a top plan view of an accessible raised garden system in accordance with a sixth preferred embodiment of the present invention;

FIG. 12B is a front elevational view of the accessible raised garden system of FIG. 12A, wherein some hidden edges are shown in broken lines;

FIG. 12C is a fragmentary front cross-sectional view of a portion of the accessible raised garden system of FIG. 12A;

FIG. 13A is a top plan view of a hexagonal raised garden system in accordance with a seventh preferred embodiment of the present invention;

FIG. 13B is a front elevational view of the hexagonal raised garden system of FIG. 13A;

FIGS. 14A-C are top plan views of the hexagonal raised garden system of FIG. 13A illustrating various sizes;

FIG. 15A is a top plan view of a two-tier hexagonal raised garden system in accordance with an eighth preferred embodiment of the present invention;

FIG. 15B is a front elevational view of the two-tier hexagonal raised garden system of FIG. 15A;

FIG. 16 is a top plan view of a raised garden system in accordance with a ninth preferred embodiment of the present invention;

FIG. 17 is a top plan view of a raised garden system in accordance with a tenth preferred embodiment of the present invention; and

FIG. 18 is a top plan view of a raised garden system in accordance with an eleventh preferred embodiment of the present invention.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, the preferred embodiments of the present invention are next described. The following description of one or more preferred embodiment(s) is merely exemplary in nature and is in no way intended to limit the invention, its application, or uses.

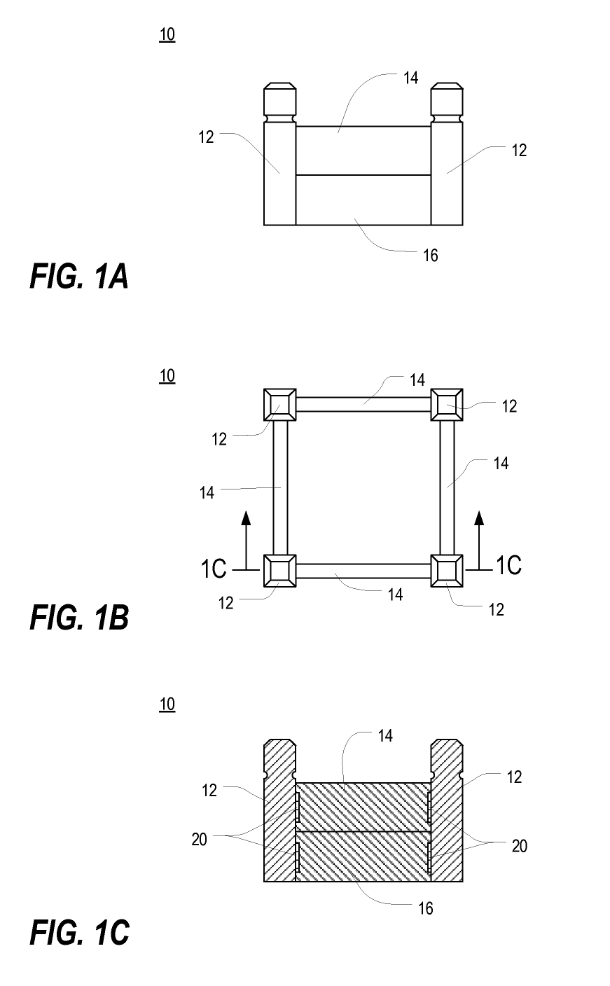

FIG. 1A is a front elevational view of a raised garden system 10 in accordance with a first preferred embodiment of the present invention, FIG. 1B is a top plan view of the raised garden system 10 of FIG. 1A; and FIG. 1C is a front cross-sectional view of the raised garden system 10 of FIG. 1A, taken along line 1C-1C. As shown therein, the raised garden system 10 includes four posts 12, eight side rails 14,16, and sixteen bracket assemblies 20.

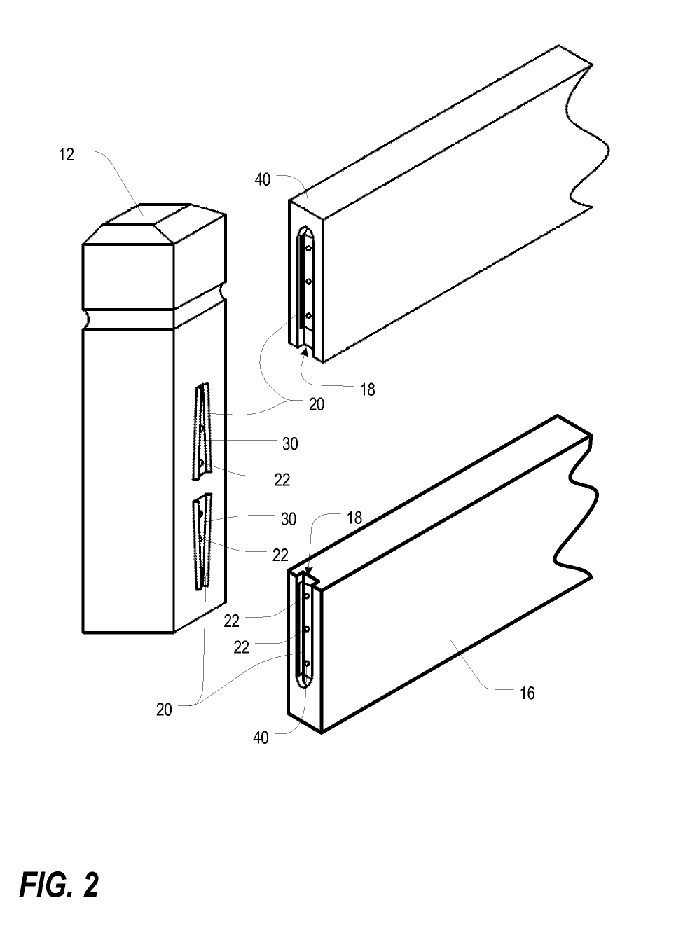

FIG. 2 is a fragmentary perspective view of a portion of the raised garden system 10 of FIG. 1A, shown in a disassembled state. As shown therein, the bracket assemblies 20 facilitate the connection of the side rails 14,16 to the posts 12. Each bracket assembly 20 includes a male bracket 30 and a female bracket 40. One of the brackets 30 is mounted on the side of a respective post 12, while the other bracket 40 is disposed within a recess 18 in the end of a respective side rail 14,16. Each bracket 30,40 is attached to its respective post 12 or side rail 14,16 using fasteners 22. For ease of manufacture and/or assembly, the female bracket 40 is preferably the bracket that is disposed within the recess 18, but it will be apparent to the Ordinary Artisan that they could be reversed in at least some embodiments. The posts 12 and side rails 14,16 may be made using conventional manufacturing methods and materials, and in at least one embodiment are made of wood, such as premium grade Western Red Cedar, that resists degradation in an outdoor environment. The brackets 30,40 and fasteners 22 are preferably made of stainless steel or other metal or other material that resists corrosion or other degradation in an outdoor environment.

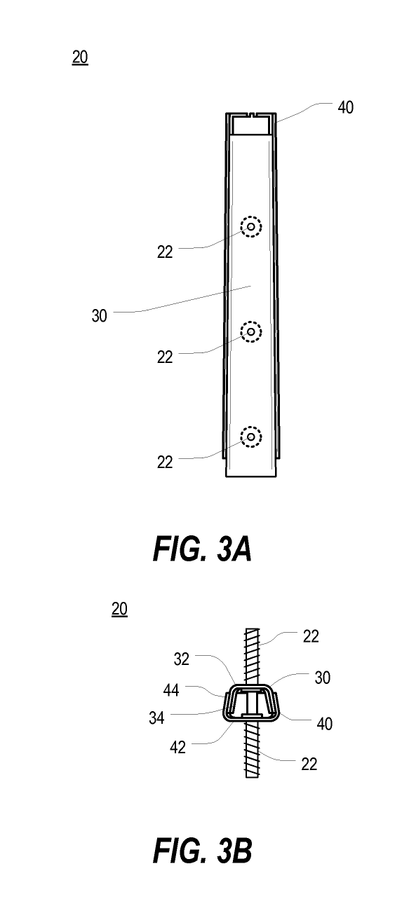

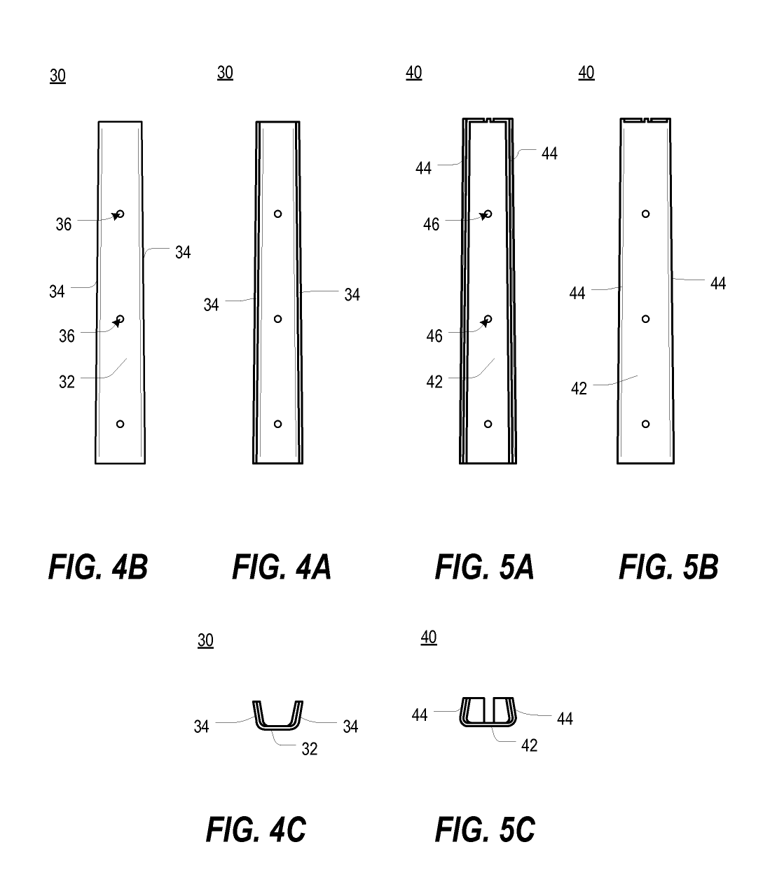

FIG. 3A is an elevational view of one of the bracket assemblies 20 of FIG. 1C, and FIG. 3B is an end view of the bracket assembly 20 of FIG. 3A. As illustrated therein, the male bracket 30 fits almost completely inside the female bracket 40 and is coupled in place by the various angles or tapers in the structures of the respective brackets 30,40. These features are perhaps best seen in FIGS. 4A-4C, which are a front elevational view, a rear elevational view and an end view, respectively, of one of the male brackets 30 of FIG. 3A, and FIGS. 5A-5C, which are a front elevational view, a rear elevational view and an end view, respectively, of one of the female brackets 40 of FIG. 3A.

The male bracket 30 includes a base member 32 and two side members 34. As perhaps best seen in FIG. 4C, the side members 34 are angled outward from the base member 32. As may be discerned in FIGS. 4A and 4B, the side members 34 are tapered inward from one end to the other (as presented in the illustrations, the upper end of the bracket 30 is narrower than the lower end). A plurality of apertures 36 permit the base member 32 to be attached via fastener 22 to a post 12 (or side rail 14,16). The bracket 30 may be formed by bending a flat strip of the stainless steel or other sheet metal.

The female bracket 40 includes a base member 42 and two side members 44. As perhaps best seen in FIG. 5C, the side members 44 are angled inward from the base member 42. As may be discerned in FIGS. 5A and 5B, the side members 44 are tapered inward from one end to the other (as presented in the illustrations, the upper end of the bracket 40 is narrower than the lower end). A plurality of apertures 46 permit the base member 42 to be attached via fastener 22 to a side rail 14,16 (or a post 12). The bracket 40 may be formed by bending a flat strip of the stainless steel or other sheet metal.

Referring again to FIGS. 3A and 3B, it will now be appreciated that when the narrow end of the male bracket 30 is inserted into the wide end of the female bracket 40, the two brackets 30,40 may be coupled together such that the inwardly-angled side members 44 of the female bracket 40 retain the outwardly-angled side members 34 of the male bracket 30 inside. The various angles and dimensions are selected such that the male bracket 30 may be forced almost completely into the female bracket 40, when a sufficient amount of force is applied, without damaging either bracket. When attached to a pair of structures, such as the post 12 and one of the side rails 14,16 of FIG. 2, the brackets 30,40 may thus be used to firmly couple or lock the structures together and to withstand considerable amounts of force applied in any direction other than along the axes of the two brackets 30,40, and in fact will even serve to hold the structures together along those axes unless a sufficient amount of force is applied to pull them back apart.

Although the benefits of the described arrangement are apparent with regard to connecting a first structure to a second structure, it will be appreciated that some difficulty is presented with regard to the use of these bracket assemblies 20 to connect a pair of side rails that are stacked edge-to-edge on top of each other in a configuration such as that shown, for example, in FIGS. 1B and 1C. This difficulty may be overcome by arranging two bracket assemblies 20 linearly, with the wide ends of the male and female brackets 30,40 disposed adjacent each other and the narrow ends of the male and female brackets 30,40 at the outer ends of the line of brackets, as shown in FIG. 2. (It will be appreciated that the tapers of the respective bracket side members 34,44 have been exaggerated to illustrate their nature.) This permits the female bracket 40 in the end of the upper side rail 14 to be lowered onto the top end of the upper male bracket 30 on the post 12, and also permits the female bracket 40 in the end of the lower side rail 16 to be raised up onto the bottom end of the lower male bracket 30 on the post 12, all without interfering with each other. The four upper side rails 14 and four lower side rails 16 may thus be assembled to the four posts 12 to produce the configuration shown in FIG. 1B, and the entire assembly may be used as the support structure for a raised garden as will be appreciated by the Ordinary Artisan.

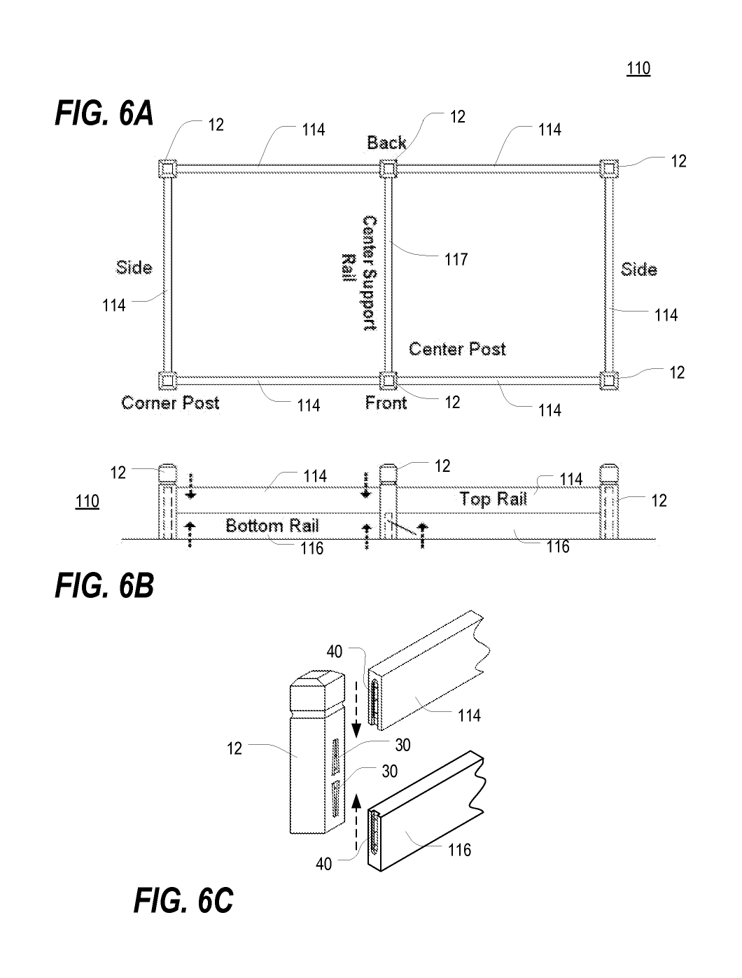

A wide variety of support structures for raised gardens may be implemented using the present invention. FIGS. 6A and 6B are a top plan view and front elevational view, respectively, of a raised garden system 110 in accordance with a second preferred embodiment of the present invention, and fragmentary perspective view of a portion of the raised garden system of FIG. 6A, illustrating the assembly thereof. As shown therein, the system 110 includes six posts 12, twelve side rails 114,116, one center support rail 117, and twenty-six bracket assemblies 20, although an additional center support rail may be added on top of the center support rail shown. The garden system 110 is preferably provided to the user with the brackets 30,40 already attached to the respective posts 12 and rails 114,116,117 and may be assembled as illustrated in FIGS. 6B and 6C and described previously.

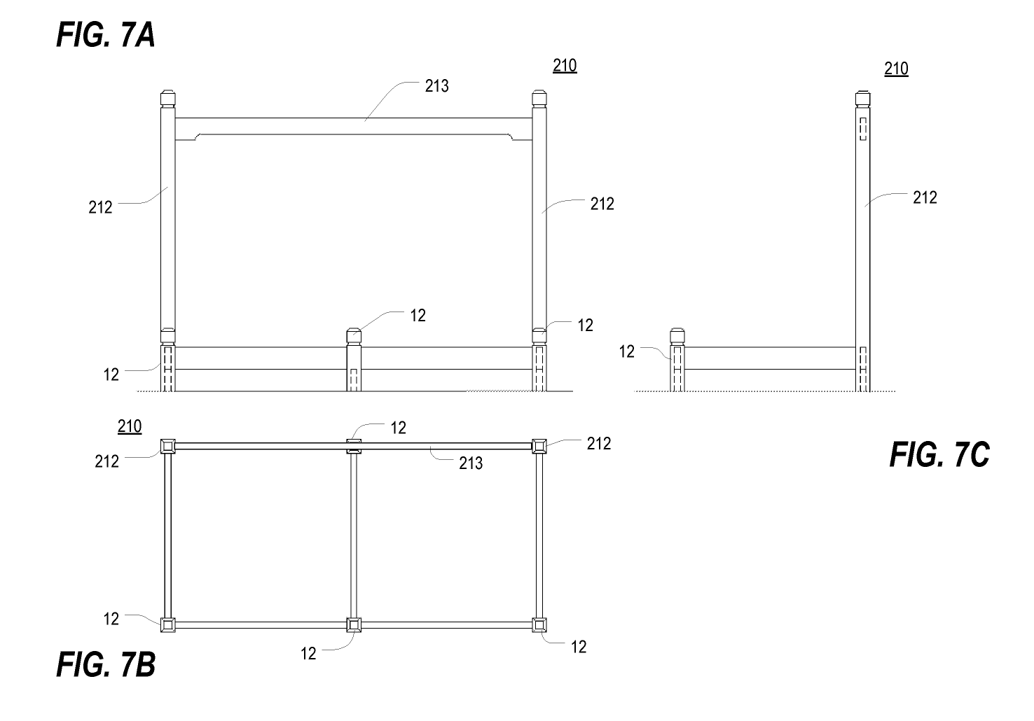

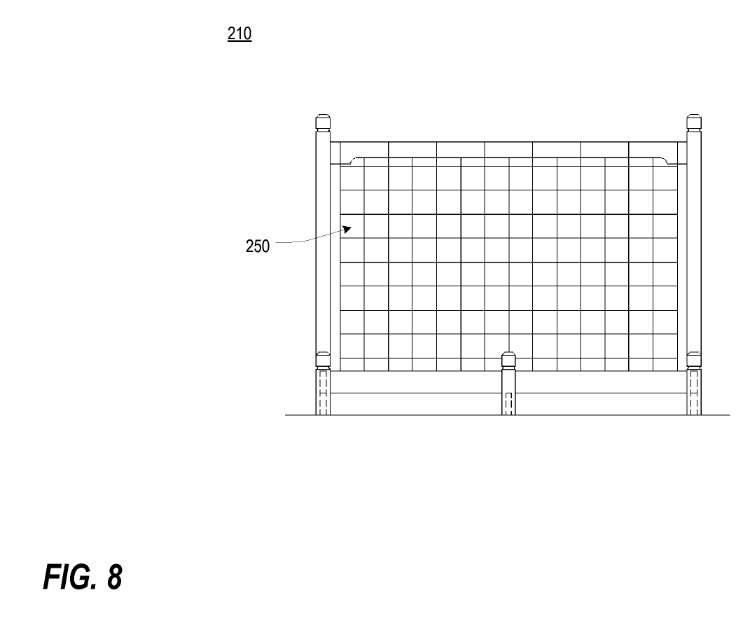

Another embodiment of a raised garden system is illustrated in FIGS. 7A-7C, wherein FIG. 7A is a front elevational view of a raised garden system 210, in accordance with a third preferred embodiment of the present invention, wherein some hidden edges are shown in broken lines; FIG. 7B is a top plan view of the raised garden system 210 of FIG. 7A; and FIG. 7C is a right side elevational view of the raised garden system 210 of FIG. 7A, wherein some hidden edges are shown in broken lines. This system 210 is similar to that of FIGS. 6A-6C except that two of the posts 12 have been replaced with elongated posts 212 and a top rail 213 is connected to the upper ends of the elongated posts 212 using another set of bracket assemblies 20. This embodiment may be useful, for example, for supporting a trellis along the rear of the resulting garden. FIG. 8 is a front plan view of the raised garden system 210 of FIG. 7A, shown with a trellis 250 installed thereon.

In yet another embodiment, an alternative arrangement is utilized for the vertical posts of a trellis 250. In particular, a raised garden system such as the system 110 of FIGS. 6A and 6B may be supplemented with a trellis 250 supported by two elongated posts attached to the back side rails 114,116 using the same bracket assemblies 20 described and illustrated previously. Like the system 210 of FIGS. 7A-7C, a top rail can be connected to the upper ends of the elongated posts, and additional bracket assemblies 20 may be used for this purpose. In one contemplated commercial use, this trellis arrangement, including the elongated posts, and top rail, and the trellis itself, may be provided as an “add-on” option to the raised garden system 110 itself. In other words, the raised garden system 110 may be manufactured and sold with or without the trellis arrangement at the consumer's option.

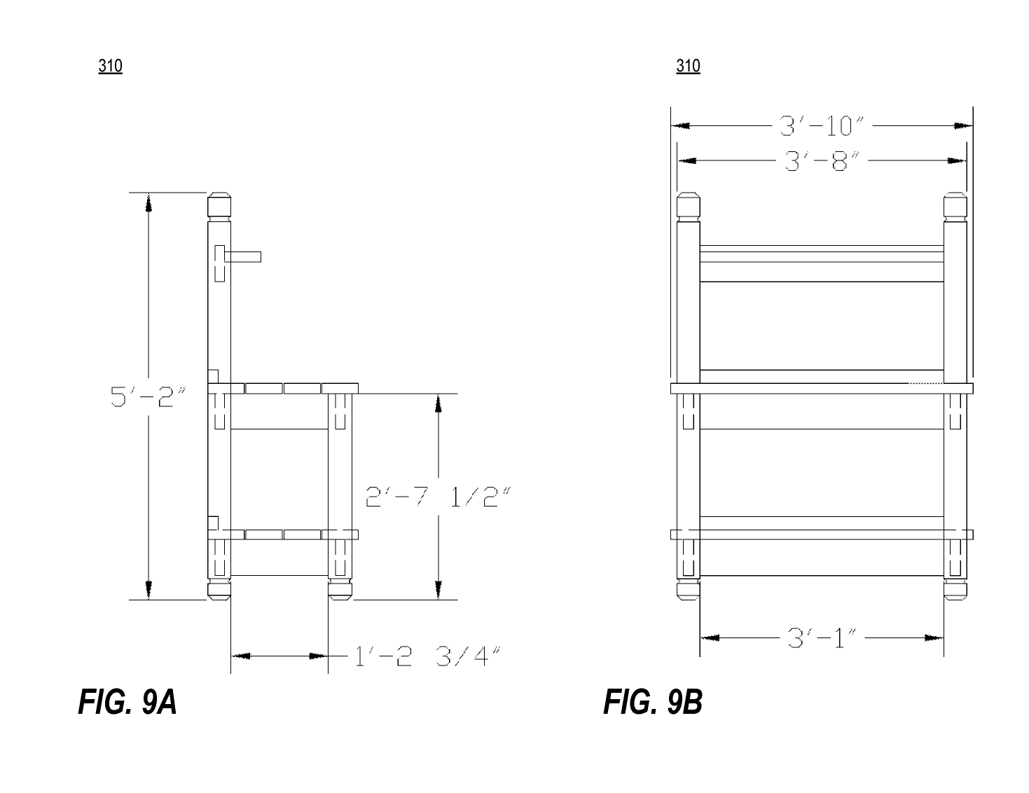

FIGS. 9A and 9B are a side elevational view and a front elevational view, respectively, of a garden workbench 310, in accordance with a fourth preferred embodiment of the present invention, wherein some hidden edges are shown in broken lines.

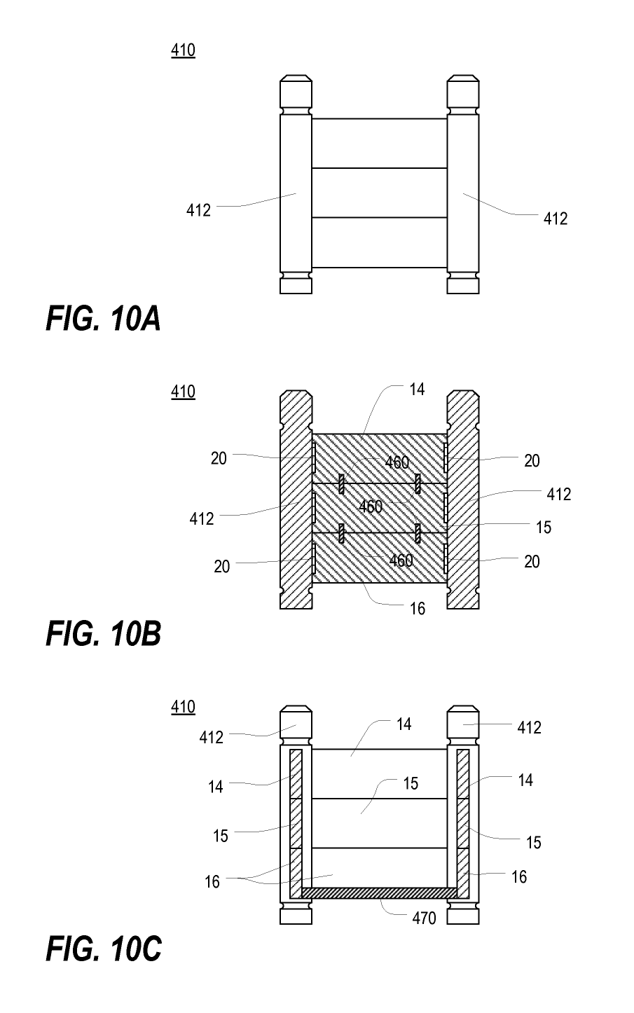

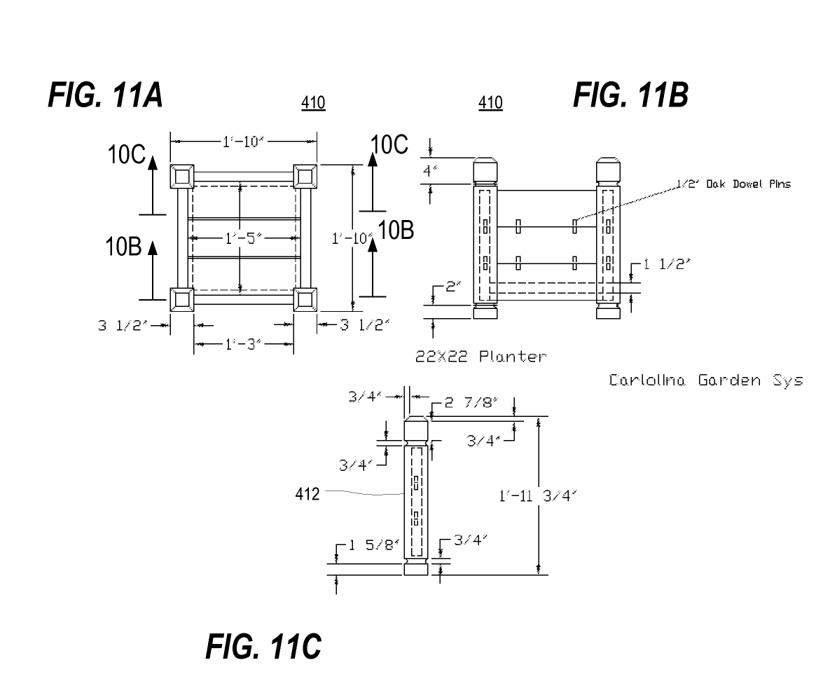

Features and aspects of the present invention may be adapted for use in garden systems having more than two side rails stacked edge-to-edge on top of each other. For example, FIG. 10A is a front elevational view of a raised garden system 410 in accordance with a fifth preferred embodiment of the present invention; FIG. 10B is a front cross-sectional view of the raised garden system 410 of FIG. 10A, taken along line 10B-10B of FIG. 11A; FIG. 10C is a front cross-sectional view of the raised garden system 410 of FIG. 10A, taken along line 10C-10C of FIG. 11A; FIG. 11A is a top plan view of the raised garden system 410 of FIG. 10A, wherein some hidden edges are shown in broken lines; FIG. 11B is a front elevational view of the raised garden system 410 of FIG. 10A, wherein some hidden edges are shown in broken lines; and FIG. 11C is a front elevational view of one of the posts 412 of the raised garden system 410 of FIG. 10A, wherein some hidden edges are shown in broken lines. As shown collectively therein, upper and lower side rails 14,16 are connected to posts 412 that are elongated relative to the posts 12 of FIGS. 1A-1C. An additional side rail 15, however, is disposed in between the upper and lower side rails 14,16 and connected thereto via registration features, which may, for example, be wooden dowels inserted into corresponding cylindrical recesses in the edges of the various rails 14,15,16. Construction of this garden system 410 is otherwise similar to that of FIGS. 1A-1C except that a floor 470 is provided.

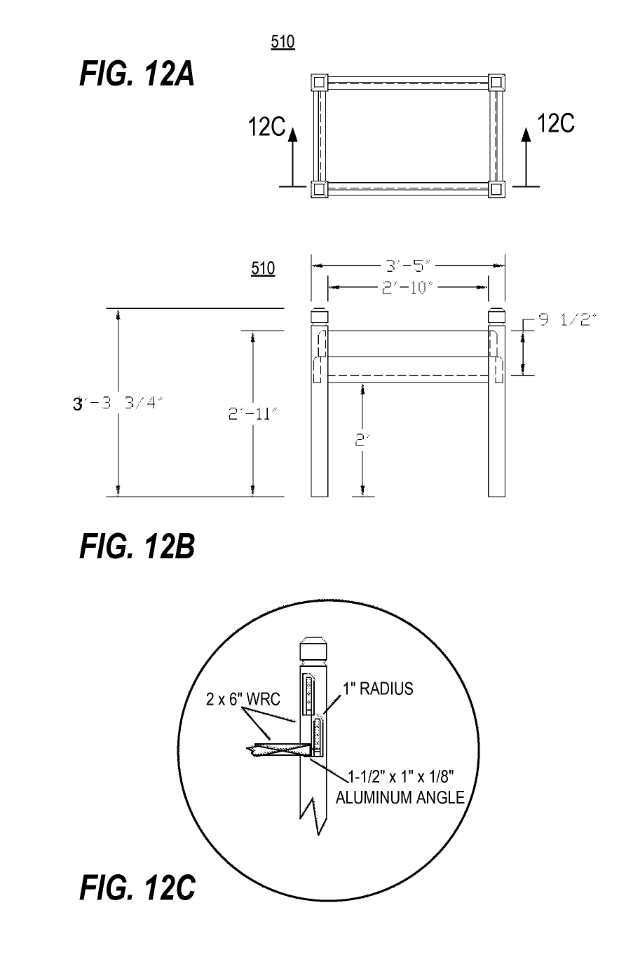

Several additional aspects and features of the present invention are illustrated in FIG. 12A is a top plan view of an accessible raised garden system 510 in accordance with a sixth preferred embodiment of the present invention; FIG. 12B is a front elevational view of the accessible raised garden system of FIG. 12A, wherein some hidden edges are shown in broken lines; and FIG. 12C is a fragmentary front cross-sectional view of a portion of the accessible raised garden system of FIG. 12A. The accessible garden system 510 is believed to meet Americans with Disabilities Act (ADA) requirements, thereby making it possible for wheelchair occupants to enjoy the raised garden experience. The accessible garden system includes four elongated posts, eight side rails, sixteen brackets 20, and a floor. Unlike other side rails, however, the rails are rounded or beveled on their top outer edges. Space is provided beneath the floor to enable the wheelchair occupant to maneuver his legs and/or the front wheels and structures of the wheelchair beneath the structure. In addition, the upper and lower side rails are offset from one another, thereby both to be installed from the top. This feature is believed to make it possible for many wheelchair occupants to assemble the system 510 with little or no assistance provided that they have sufficient upper body strength, range of movement and/or dexterity. Specific dimensions believed to meet ADA requirements are illustrated in FIG. 12B.

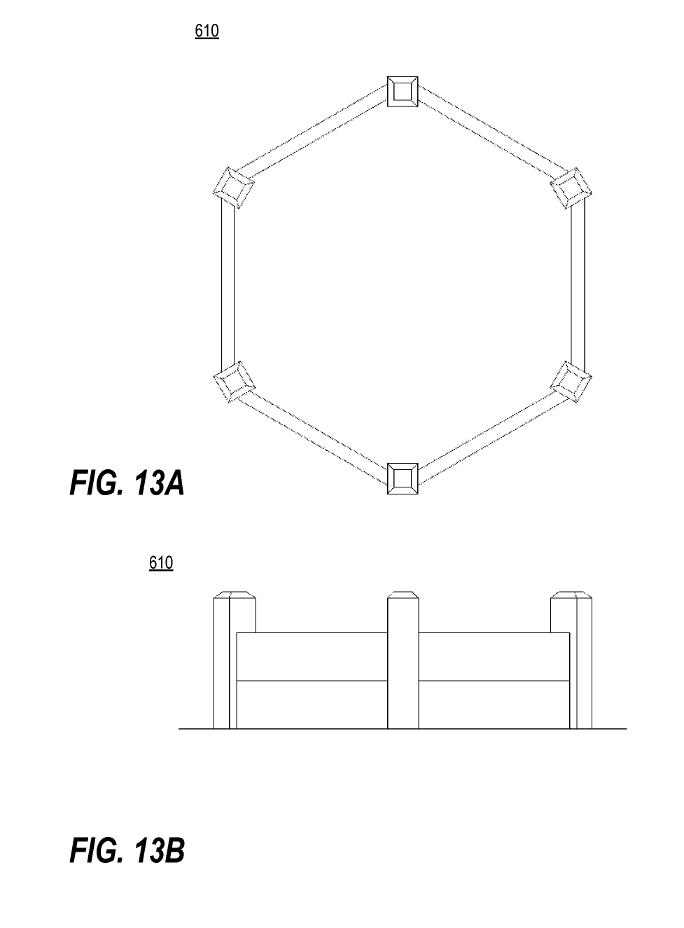

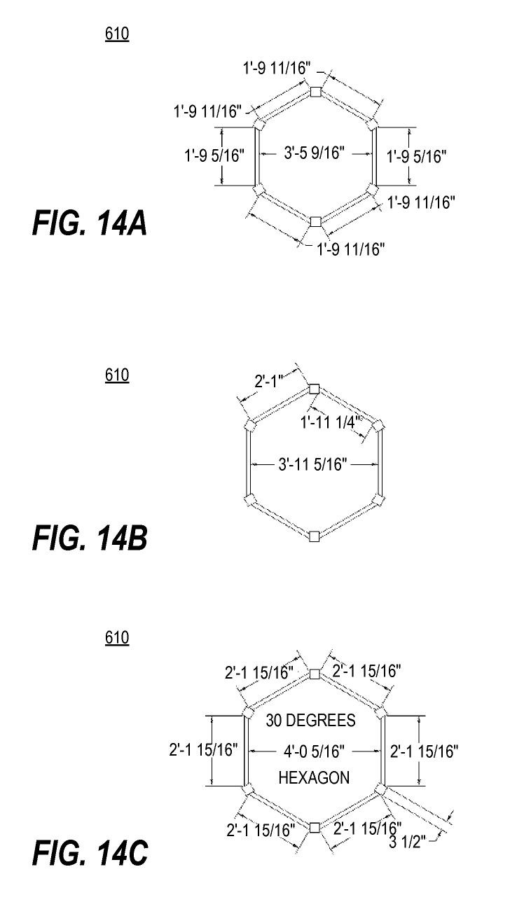

Structures having a footprint that is not entirely dependent on right angles may also be produced using the same bracket assemblies 20 and the same general techniques. For example, FIG. 13A is a top plan view of a hexagonal raised garden system 610 in accordance with a seventh preferred embodiment of the present invention, and FIG. 13B is a front elevational view of the hexagonal raised garden system 610 of FIG. 13A. In at least one embodiment, the ends of the side rails are mitered at the desired angles, and the recesses at the ends of the side rails are adjusted to accommodate the brackets 40, but the posts themselves remain the same, and assembly is generally similar to that of the raised garden system of FIGS. 1A-1C. As with the square or rectangular raised garden systems described previously, hexagonal systems 610 of different dimensions may be produced. FIGS. 14A-C are top plan views of the hexagonal raised garden system 610 of FIG. 13A illustrating various sizes.

A variety of appealing structures may be created from the various aspects and features described and illustrated herein.

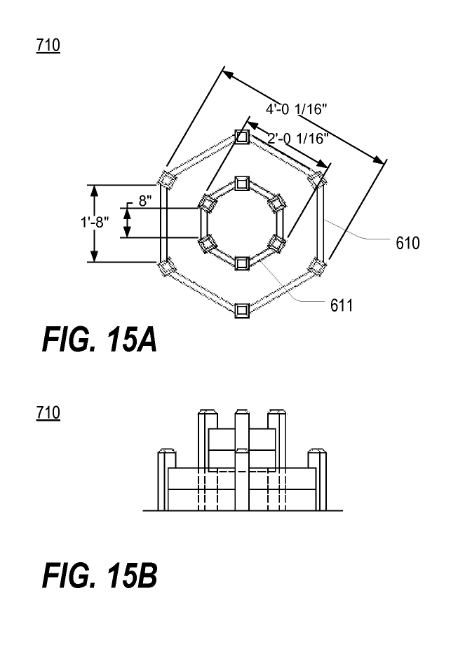

FIG. 15A is a top plan view of a two-tier hexagonal raised garden system 710 in accordance with an eighth preferred embodiment of the present invention; and FIG. 15B is a front elevational view of the two-tier hexagonal raised garden system 710 of FIG. 15A. As shown therein, a raised garden system 610 like that of FIGS. 13A is combined with a second raised garden system 611, having a smaller footprint than the first (as shown in FIG. 15A), that is similar to the raised garden system of FIGS. 13A and 13B but uses elongated posts to raise the inner system 611 above the outer system 610.

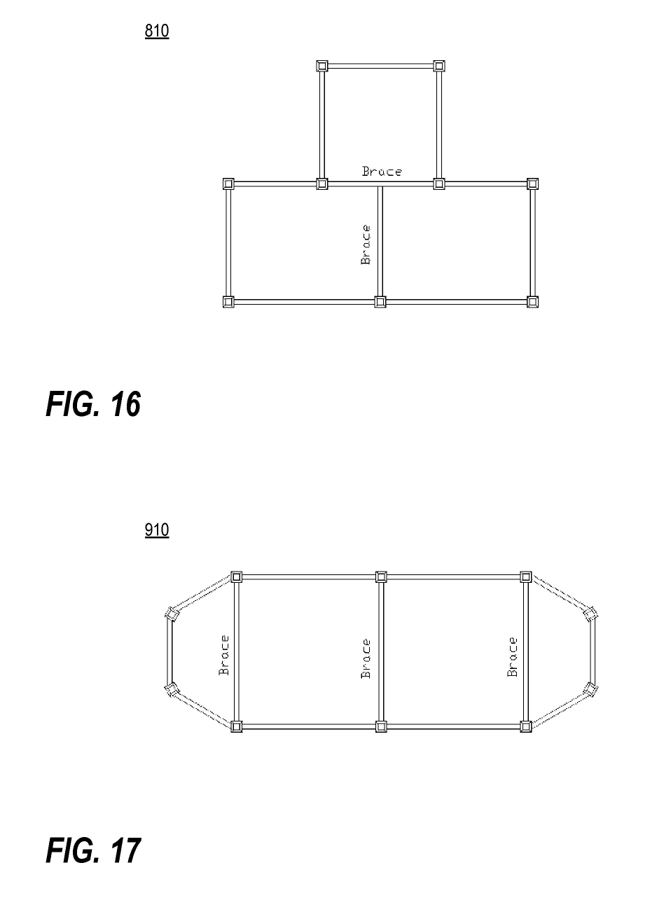

FIG. 16 is a top plan view of a raised garden system 810 in accordance with a ninth preferred embodiment of the present invention.

FIG. 17 is a top plan view of a raised garden system 910 in accordance with a tenth preferred embodiment of the present invention.

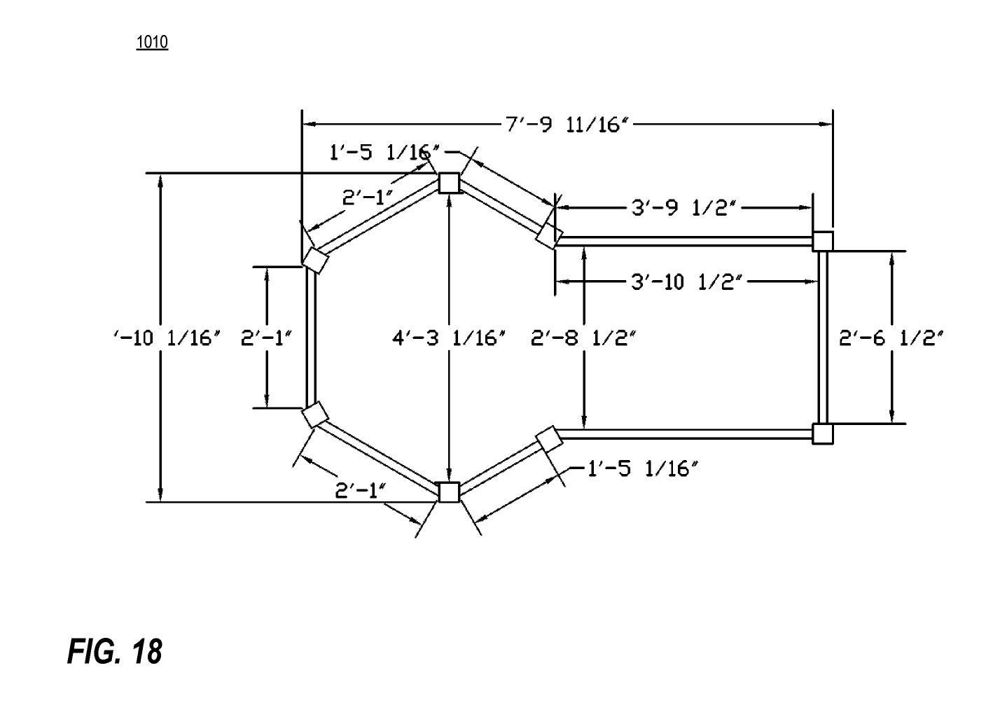

FIG. 18 is a top plan view of a raised garden system 1010 in accordance with a eleventh preferred embodiment of the present invention.

In at least one commercial embodiment, raised garden systems are packaged and sold in the form of unassembled kits. For example, one such kit may be used to produce the raised garden system 110 of FIGS. 6A-6C. Included in the kit are four outside corner posts, with male brackets attached to two adjacent sides of each post; two center posts, with male brackets are attached to three adjacent sides of each post 12 (with the single male bracket 30 being used to attach the center support rail); eight long front and rear rails; four short sides rails; one short center support rail; one 8 oz. rubber mallet; one cedar tap block; and printed assembly instructions. The printed instructions include a parts list and step-by-step instructions describing the following assembly process.

First, it is recommended that the user should initially assemble the kit on a firm, hard surface, such as their driveway or garage floor. All the cedar pieces may be positioned on the driveway before assembly is begun. The user may be referred to FIGS. 6A and 6B, which may be reproduced in the instructions. It may be noted that the front and back rails are interchangeable, as are the side and center support rails. The corner posts may not be interchangeable; they can only be positioned one way.

The center support rail and all bottom rails (front, back and side rails) are attached to the posts from the bottom up as shown in FIG. 6C, which may be reproduced in the instructions. The top rails may be attached to the posts from the top down.

The bottom rail may be aligned with a corner post and the brackets 30,40 connected together until there is a snug fit. The use may continue attaching all the bottom rails and the center support rail to the respective posts. After all bottom rails and the center support rail are attached, the tap block and rubber mallet may be used to tighten the brackets by placing the tap block on top of the respective post and using the mallet to tighten the joint. The mallet may continue to be used until the bottom of the post and the bottom of the bottom rail are aligned.

Once the user has completed firmly attaching the front, back, sides and center support rail to the posts, they can carry the entire partially assembled raised garden system to the desired installation location in their yard. The partially assembled raised garden system may be positioned and checked to see if the area is relatively level and clear of protruding roots or rocks. Once in final position, final assembly may be continued by attaching the top rails from the top down in the same manner as with the bottom rails. It will be noted that when trying to align the top rails to the posts, the fit will be tight. The tap block may be placed on top of the top rail next to the post and the joint may be tightened by using the rubber mallet. Alternately, each side of the rail may be tapped until the joint between the bottom rail and top rail are tight.

A somewhat similar kit may be used to produce the raised garden system 210 of FIG. 8 by replacing two of the posts with elongated posts, including the top rail, and including netting or the like to form the trellis. The instructions may cover this version as well by explaining to the user that the assembly process is somewhat similar to that described above but with some exceptions. After the trellis posts are connected to the bottom rails, the entire raised garden bed may be rotated by the trellis posts and laid down where the trellis posts are lying parallel on the driveway. This will allow the user to tighten the connection between the trellis posts and the bottom rails from the bottom. Also, to install the netting to the trellis top rail, the netting may be weaved through the top rail before attaching the top rail to the trellis posts. The netting should preferably be pulled tight from the bottom and the bottom of the netting left in the raised garden, covered by soil.

The various raised garden systems shown and described herein, including kits, as well as accessories therefor, may be designed, developed, manufactured and distributed to the wholesale and retail consumer market. The kits are economical and easy-to-assemble and utilize materials that are considered sustainable, renewable and ecologically friendly. The unique attachment brackets allow the consumer to assemble or disassemble the kits quickly, easily, and without tools or hardware.

The systems and related accessories are designed and manufactured using materials that are considered sustainable, renewable and ecologically friendly. The systems recognize that one size does not fit all and that individual customer needs will vary based on their physical ability and the size and location of their usable space. The brackets enable users to assemble their raised garden systems quickly, easily, and without tools. A wide variety of raised bed designs, shapes, and sizes may be provided to meet individual user needs. Additionally, the unique connection brackets allow customers to easily expand or redesign their existing raised garden system instead of having to purchase additional raised bed garden kits, thereby saving the customer time and money.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A raised garden system, comprising:
(a) a plurality of structural members, including a plurality of side rails;
(b) a plurality of tapered bracket assemblies, wherein each bracket assembly includes a tapered male bracket that slides into a tapered female bracket;
(c) wherein each side rail may be connected to at least one other structural member via a bracket assembly, wherein one of the male bracket and the female brackets is fastened to the side rail and the other of the male bracket and the female bracket is fastened to the other structural member; and
(d) wherein, when assembled, the structural members form a raised garden, the sides of which are at least partially formed from the side rails, and which is held together by the tapered bracket assemblies.

2. The raised garden system of claim 1, wherein the plurality of structural members further includes a plurality of posts, and wherein the side rails are connected to the posts using the tapered bracket assemblies.

3. The raised garden system of claim 2, wherein two side rails are stacked edge-to-edge on top of each other.

4. The raised garden system of claim 3, wherein a first of the two side rails is an upper side rail and is connected to an upper bracket on a post by sliding first tapered male and female brackets together from the top, and wherein a second of the two side rails is a lower side rail and is connected to a lower bracket on the post by sliding second tapered male and female brackets together from the bottom.

5. The raised garden system of claim 2, wherein the side rails are connectable to the posts without tools using the tapered bracket assemblies.

6. The raised garden system of claim 2, wherein the side rails, posts and tapered bracket assemblies are provided to a consumer in the form of a kit to be assembled by the consumer.

7. The raised garden system of claim 1, further comprising a pair of elongated posts for supporting a trellis, the elongated posts being connectable to one or more side rails using tapered bracket assemblies.

8. The raised garden system of claim 7, wherein the elongated posts are adapted to be connected on sides of the side rails.

9. The raised garden system of claim 8, wherein the elongated posts are provided with the side rails and tapered bracket assemblies to a consumer in the form of a kit to be assembled by the consumer.

10. The raised garden system of claim 7, wherein the elongated posts form corner posts of the raised garden formed by the structural members.

11. The raised garden system of claim 1, wherein the structural members include four corner posts, four upper side rails and four lower side rails, which, together with sixteen tapered bracket assemblies, form a rectangular garden.

12. The raised garden system of claim 1, wherein the structural members include four corner posts, two side posts, six upper side rails and six lower side rails, which, together with twenty-four tapered bracket assemblies, form a rectangular garden.

13. The raised garden system of claim 1, wherein the structural members include six corner posts, six upper side rails and six lower side rails, which, together with twenty-four tapered bracket assemblies, form a hexagonal garden.
